(19) United States
(12) Patent Application Publication
(10) Pub. No.: US 2020/0363192 A1
(43) Pub. Date: Nov. 19, 2020

(54) METHOD OF MEASURING FILM THICKNESS

(71) Applicants: Tatsuji NAGAOKA, Nagakute-shi (JP); Hiroyuki NISHINAKA, Kyoto-shi (JP); Masahiro YOSHIMOTO, Kyoto-shi (JP)

(72) Inventors: Tatsuji NAGAOKA, Nagakute-shi (JP); Hiroyuki NISHINAKA, Kyoto-shi (JP); Masahiro YOSHIMOTO, Kyoto-shi (JP)

(73) Assignees: TOYOTA JIDOSHA KABUSHIKI KAISHA, Toyota-shi (JP); NATIONAL UNIVERSITY CORPORATION KYOTO INSTITUTE OF TECHNOLOGY, Kyoto-shi (JP)

(21) Appl. No.: 16/861,521

(22) Filed: Apr. 29, 2020

(30) Foreign Application Priority Data
May 15, 2019 (JP) 2019-092434

(51) Int. Cl. G01B 11/06

(52) U.S. Cl. CPC G01B 11/0625; G01B 2210/56; G01B 11/0675

(57) ABSTRACT

A method of measuring a film thickness is provided. A first semiconductor layer and a second semiconductor layer may be mainly constituted of a same material and may be of a same conductivity type. A film thickness measuring device may be configured such that light emitted from a light source is reflected by a semiconductor substrate fixed to a stage after having been reflected by a half mirror, and the light reflected by the semiconductor substrate passes through the half mirror and enters a photodetector. The light reflected by the semiconductor substrate may include first reflected light reflected by a surface of the second semiconductor layer and second reflected light reflected by an interface between the second semiconductor layer and the first semiconductor layer. A film thickness calculator may calculate the film thickness of the second semiconductor layer based on the light detected by the photodetector.

### CROSS-REFERENCE TO RELATED APPLICATION

This application claims priority to Japanese Patent Application No. 2019-092434, filed on May 15, 2019, the entire contents of which are incorporated herein by reference.

### TECHNICAL FIELD

The disclosure herewith relates to a method of measuring a film thickness.

### BACKGROUND

Japanese Patent Application Publication No. 2019-9329 describes a method of measuring a thickness of a gallium nitride film that is formed on a gallium nitride substrate by epitaxial growth, by Fourier transform infrared spectroscopy or infrared spectroscopic ellipsometry.

### SUMMARY

The disclosure herein provides a technology that enables accurate measurement of a film thickness of an upper semiconductor layer out of stacked two semiconductor layers, which is different from the technology of Japanese Patent Application Publication No. 2019-9329.

The present disclosure discloses a method of measuring a film thickness of a second semiconductor layer covering a surface of a first semiconductor layer by using a film thickness measuring device. The first semiconductor layer and the second semiconductor layer may be mainly constituted of a same material and may be of a same conductivity type. The film thickness measuring device may comprise a light source, a stage, a half mirror, a photodetector, and a film thickness calculator. The method may comprise fixing a semiconductor substrate including the first semiconductor layer and the second semiconductor layer to the stage, and measuring the film thickness of the second semiconductor layer with the film thickness measuring device. The film thickness measuring device may be configured such that light emitted from the light source is reflected by the semiconductor substrate fixed to the stage after having been reflected by the half mirror, and the light reflected by the semiconductor substrate passes through the half mirror and enters the photodetector. The light reflected by the semiconductor substrate may include first reflected light reflected by a surface of the second semiconductor layer and second reflected light reflected by an interface between the second semiconductor layer and the first semiconductor layer. The film thickness calculator may calculate the film thickness of the second semiconductor layer based on the light detected by the photodetector.

The above-described method enables accurate measurement of the film thickness of the second semiconductor layer.

### BRIEF DESCRIPTION OF DRAWINGS

FIG. 1 is a cross-sectional view of a semiconductor substrate 10;

FIG. 2 is a diagram showing an example of a distribution of a dopant concentration in a thickness direction of the semiconductor substrate 10;

FIG. 3 is a diagram schematically showing a configuration of a film thickness measuring device 100;

FIG. 4 is a diagram showing another example of the distribution of the dopant concentration in the thickness direction of the semiconductor substrate 10;

FIG. 5 is a diagram showing an example of a distribution of a crystal defect density in the thickness direction of the semiconductor substrate 10;

FIG. 6 is a diagram showing an example of changes in resistance in the thickness direction of the semiconductor substrate 10;

FIG. 7 is a diagram showing an example of a distribution of an oxygen atoms concentration in the thickness direction of the semiconductor substrate 10;

FIG. 8 is a diagram showing another example of the distribution of the crystal defect density in the thickness direction of the semiconductor substrate 10;

FIG. 9 is a cross-sectional view of a semiconductor substrate 20;

FIG. 10 is a diagram showing an example of distributions of dopant concentrations in a thickness direction of the semiconductor substrate 20; and

FIG. 11 is a diagram showing an example of a distribution of a crystal defect density in the thickness direction of the semiconductor substrate 20.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved methods for measuring a film thickness.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

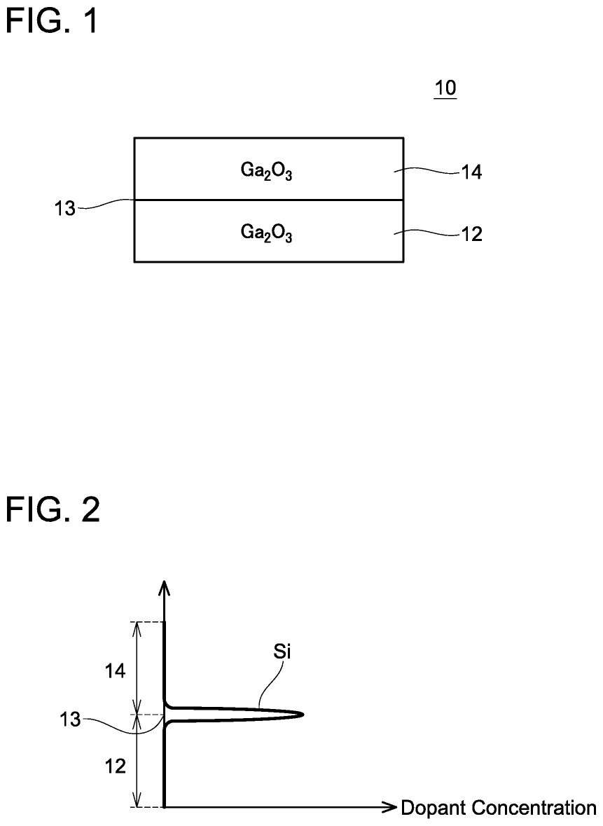

FIG. 1 is a cross-sectional view of a semiconductor substrate 10 whose film thickness is to be measured by a film thickness measuring device 100 used in a measuring method of the present embodiment. As shown in FIG. 1, the semiconductor substrate 10 includes a first semiconductor layer 12 and a second semiconductor layer 14. The second semiconductor layer 14 covers an upper surface of the first semiconductor layer 12. The first semiconductor layer 12 is constituted of a semiconductor material that is mainly constituted of a wide gap semiconductor. In the present embodiment, gallium oxide (Ga₂O₃) is employed as the wide gap semiconductor. The first semiconductor layer 12 is of n-type. The second semiconductor layer 14 is disposed on the upper surface of the first semiconductor layer 12. The second semiconductor layer 14 is constituted of a semiconductor material that is mainly constituted of a wide gap semiconductor. In the present embodiment, gallium oxide (Ga₂O₃) is employed as the wide gap semiconductor. The second semiconductor layer 14 is of n-type. The materials that mainly constitute the first semiconductor layer 12 and the second semiconductor layer 14 are not limited to particular ones, and only need to be constituted of the same semiconductor material. Moreover, the first semiconductor layer 12 and the second semiconductor layer 14 only need to be of the same conductivity type, and both of them may be of p-type. Moreover, the semiconductor substrate 10 may have a switching element disposed therein, and the second semiconductor layer 14 may function as a drift layer of the aforementioned switching element.

The semiconductor substrate 10 contains a dopant. FIG. 2 shows a distribution of the dopant concentration contained in the semiconductor substrate 10 in a thickness direction of the semiconductor substrate 10. As shown in FIG. 2, the semiconductor substrate 10 contains silicon (Si) as the dopant. The concentration of silicon is at its peak at an interface 13 between the first semiconductor layer 12 and the second semiconductor layer 14. Such a semiconductor substrate 10 can be obtained by, for example, injecting silicon into the upper surface of the first semiconductor layer 12, and then epitaxially growing the second semiconductor layer 14 on the upper surface of the first semiconductor layer 12. Alternatively, the above-described semiconductor substrate 10 can also be obtained by, for example, exposing the upper surface of the first semiconductor layer 12 to gas that contains silicon such that silicon adheres to the upper surface of the first semiconductor layer 12, and then epitaxially growing the second semiconductor layer 14 on the upper surface of the first semiconductor layer 12. The dopant contained in the semiconductor substrate 10 is not limited to silicon, and may be another group IV element such as carbon (C).

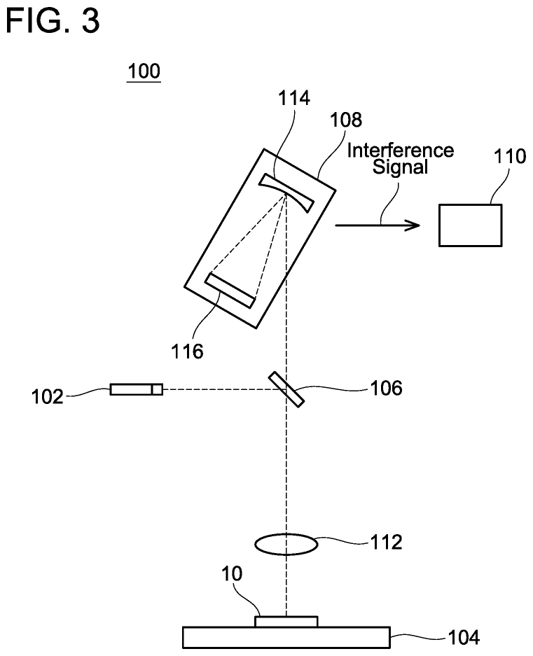

Next, the film thickness measuring device 100 used in the measuring method of the present embodiment will be described. As shown in FIG. 3, the film thickness measuring device 100 comprises a light source 102, a stage 104, a half mirror 106, a photodetector 108, a film thickness calculator 110, and an objective lens 112.

The light source 102 is configured to emit light in a predetermined wavelength band. In the present embodiment, the light source 102 emits visible light (approximately 400 to 800 nm) or ultraviolet light (approximately 200 to 400 nm).

The semiconductor substrate 10 to be measured is fixed to the stage 104. The semiconductor substrate 10 is fixed such that a lower surface of the first semiconductor layer 12 abuts the stage 104. When the semiconductor substrate 10 is fixed on the stage 104, therefore, an upper surface of the second semiconductor layer 14 is oriented upward.

The half mirror 106 is configured to reflect a part of incident light and allows the remainder of the incident light to pass therethrough. The half mirror 106 is disposed above the stage 104. Specifically, the half mirror 106 is disposed directly above the semiconductor substrate 10 fixed on the stage 104. The half mirror 106 is disposed to be inclined relative to the normal to an upper surface of the stage 104. The half mirror 106 is inclined at an angle that allows the light emitted from the light source 102 and reflected by the half mirror 106 to be emitted onto the semiconductor substrate 10 mounted on the stage 104. The light emitted from the light source 102 is therefore reflected by the half mirror 106 and then enters an upper surface of the semiconductor substrate 10 at an angle substantially perpendicular thereto.

The light emitted onto the upper surface of the semiconductor substrate 10 is reflected by the upper surface thereof. A part of the light reflected by the upper surface of the semiconductor substrate 10 passes through the half mirror 106. The light passed through the half mirror 106 enters the photodetector 108.

The photodetector 108 is configured to generate an interference signal based on interference light obtained from the light reflected by the semiconductor substrate 10. The photodetector 108 includes a diffraction grating 114 and a photoreceptor 116. The diffraction grating 114 is configured to split the incident light to the photodetector 108 by wavelength to generate an interference fringe pattern. The photoreceptor 116 is configured to detect the light split by the diffraction grating 114 by wavelength to generate an interference signal. The film thickness calculator 110 is configured to perform various processes on the interference signal generated by the photoreceptor 116 to calculate a film thickness of the second semiconductor layer 14. The photodetector 108 and the film thickness calculator 110 will hereinafter be described in further details.

The objective lens 112 is disposed between the stage 104 and the half mirror 106. Moving the objective lens 112 in a direction of its optical axis (i.e., a direction linking the stage 104 and the half mirror 106) can change a focus position of the light emitted from the light source 102.

When the film thickness of the second semiconductor layer 14 of the semiconductor substrate 10 is to be measured with the film thickness measuring device 100, the semiconductor substrate 10 to be measured is firstly fixed on the stage 104. The light source 102 then emits light. The light emitted from the light source 102 is reflected by the half mirror 106, and then enters the semiconductor substrate 10 fixed on the stage 104 through the objective lens 112. The light that entered the semiconductor substrate 10 is reflected by the upper surface of the second semiconductor layer 14 and by the interface 13 between the second semiconductor layer 14 and the first semiconductor layer 12. The light reflected by the upper surface of the second semiconductor layer 14 will hereinafter be termed first reflected light, and the light that passed through the second semiconductor layer 14 and then was reflected by the interface 13 between the second semiconductor layer 14 and the first semiconductor layer 12 will hereinafter be termed second reflected light.

The first reflected light and the second reflected light pass through the half mirror 106 through the objective lens 112, and then enter the photodetector 108. The first reflected light and the second reflected light that have entered the photodetector 108 then enter the diffraction grating 114. Each of the first reflected light and the second reflected light that have entered the diffraction grating 114 is split by wavelength. Each split light is reflected by the diffraction grating 114 and inputted into the photoreceptor 116. A line sensor (polychromator) can be used as the photoreceptor 116. The photoreceptor 116 measures interferences between the first reflected light and the second reflected light by wavelength. The photodetector 108 then generates an interference signal in accordance with the intensity of the measured interference light, and inputs this interference signal into the film thickness calculator 110.

Based on the inputted interference signal, the film thickness calculator 110 calculates the film thickness of the second semiconductor layer 14. Specifically, the film thickness calculator 110 extracts each wavelength whose reflectivity is at its peak from the inputted interference signal, and calculates the film thickness of the second semiconductor layer 14 based on the extracted wavelengths. In the above-described manner, the film thickness of the second semiconductor layer 14 can be calculated. As such, the present embodiment enables measurement of the film thickness of the second semiconductor layer 14 by the film thickness measuring device in which the optical path of the light that enters the semiconductor substrate 10 partially overlaps the optical path of the light reflected from the semiconductor substrate 10.

In the present embodiment, the light source 102 emits visible light or ultraviolet light (approximately 200 to 800 nm). In other words, the emitted light has a wavelength shorter than a wavelength of light that is mainly used for infrared spectroscopy (approximately 0.8 to 4 μm). Generally, for accurate measurement of film thickness, emitted light is required to have a wavelength shorter than the film thickness to be measured. Thus, the present embodiment enables suitable measurement of the film thickness of the second semiconductor layer 14 of the semiconductor substrate 10 on the order of micrometers.

Moreover, in the present embodiment, the objective lens 112 is disposed between the stage 104 and the half mirror 106. In other words, the objective lens 112 is disposed on the optical path where the light entering the semiconductor substrate 10 overlaps the light reflected from the semiconductor substrate 10. The present embodiment therefore facilitates adjustment of the focus position of the light emitted from the light source 102.

Moreover, the semiconductor substrate 10 used for the measurement of the present embodiment contains the dopant, and the concentration of this dopant is at its peak at the interface 13 between the first semiconductor layer 12 and the second semiconductor layer 14. The interface 13 therefore has optical properties (e.g., refractive index, and the like) different from those of the other portion of the semiconductor substrate 10. This facilitates detection of the light reflected by the interface 13 (i.e., the second reflected light), and enables accurate detection of the position of the interface 13.

In the semiconductor substrate 10 of the above-mentioned embodiment, although the concentration of the dopant is at its peak at the interface 13 between the first semiconductor layer 12 and the second semiconductor layer 14, the concentration of the dopant may be at its peak at a portion other than the interface 13.

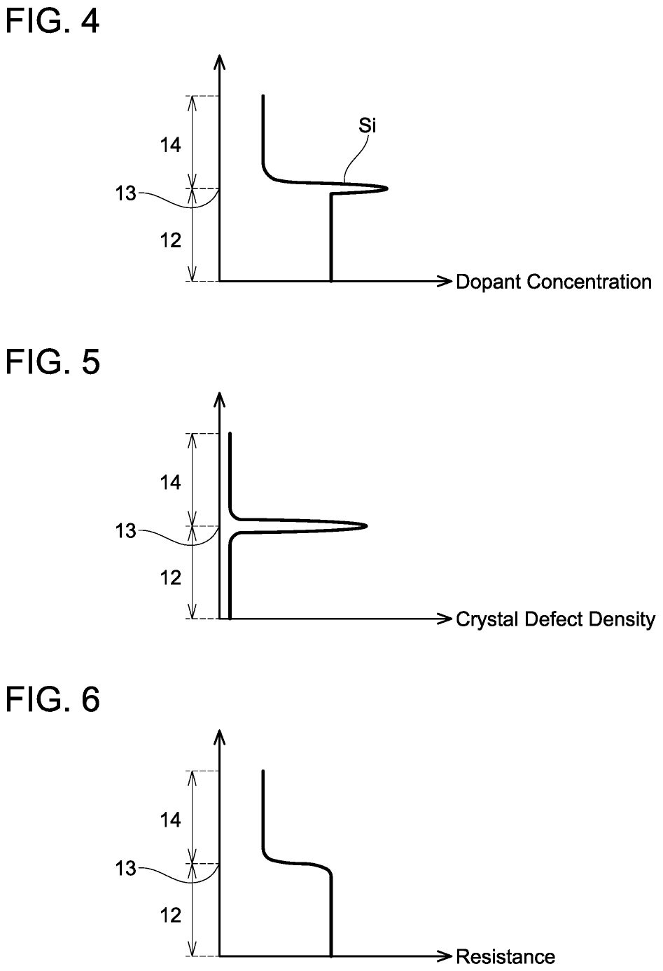

As shown in FIG. 4, the semiconductor substrate 10 whose film thickness is measured by the method of the present embodiment may include the first semiconductor layer 12 doped with Si at a constant concentration in its depth direction and the second semiconductor layer 14 doped with Si at a constant concentration in its depth direction. The concentration of Si in the second semiconductor layer 14 is lower than that in the first semiconductor layer 12. This configuration can be obtained by, for example, preparing the first semiconductor layer 12 doped with Si, further injecting Si into the upper surface of the first semiconductor layer 12, and then epitaxially growing the second semiconductor layer 14 which is doped with Si at a concentration lower than that in the first semiconductor layer 12 on the upper surface of the first semiconductor layer 12.

When the semiconductor substrate 10 has the dopant concentration distribution shown in FIG. 4, a crystal defect density is at its peak (local maximum value) at the depth where the concentration of Si is at its peak (i.e., at the interface 13 between the first semiconductor layer 12 and the second semiconductor layer 14) as shown in FIG. 5. This semiconductor substrate 10 has the locally high crystal defect density at the interface 13, and hence the measurement of the semiconductor substrate 10 by the film thickness measuring device 100 reveals that the interface 13 has optical properties different from those of the other portions of the semiconductor substrate 10. This facilitates detection of the light reflected by the interface 13, and enables accurate detection of the position of the interface 13. In general, a semiconductor layer that has a higher crystal defect density has a higher resistance. In this semiconductor substrate 10, however, not only is the crystal defect density at its peak at the interface 13, but also the concentration of Si is high at the interface 13, and thus the resistance at the interface 13 is substantially the same as the resistance in the first semiconductor layer 12 as shown in FIG. 6. Even if the resistance of the semiconductor substrate 10 does not drastically change at the interface 13 as such, the crystal defect density is high at the interface 13, thereby the position of the interface 13 can be accurately detected.

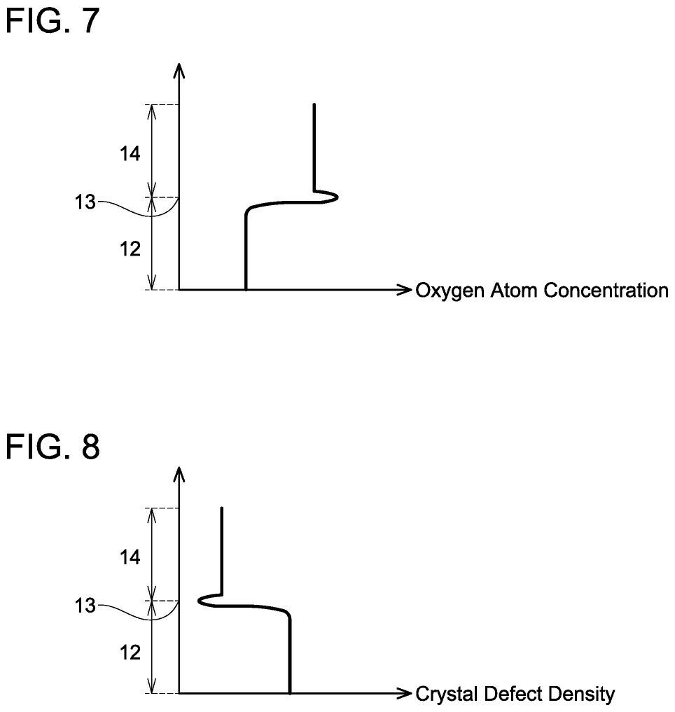

As shown in FIG. 7, for example, the concentration of oxygen atoms in the semiconductor substrate 10 may be at its peak at the interface 13 between the first semiconductor layer 12 and the second semiconductor layer 14. This semiconductor substrate 10 can be obtained by, for example, preparing the first semiconductor layer 12 that has been annealed in a nitrogen atmosphere for a long time and then annealed in an oxygen atmosphere for a short time, and epitaxially growing the second semiconductor layer 14 on the upper surface of the first semiconductor layer 12. Annealing the first semiconductor layer 12 in the nitrogen atmosphere for a long time decreases the concentration of oxygen atoms in the first semiconductor layer 12 and increases the crystal defect density in the first semiconductor layer 12. Subsequently, annealing the first semiconductor layer 12 in the oxygen atmosphere for a short time allows oxygen to be captured into a vicinity of the upper surface of the first semiconductor layer 12, which decreases the crystal defect density in the vicinity of the upper surface of the first semiconductor layer 12. Subsequently, the second semiconductor layer 14 is formed thereon, which results in the semiconductor substrate 10 in which the crystal defect density has a local minimum value at the interface 13 between the first semiconductor layer 12 and the second semiconductor layer 14 as shown in FIG. 8. This semiconductor substrate 10 has the locally low crystal defect density at the interface 13, and hence the measurement of the semiconductor substrate 10 by the film thickness measuring device 100 reveals that the interface 13 has optical properties different from those of the other portions of the semiconductor substrate 10. This enables accurate detection of the position of the interface 13.

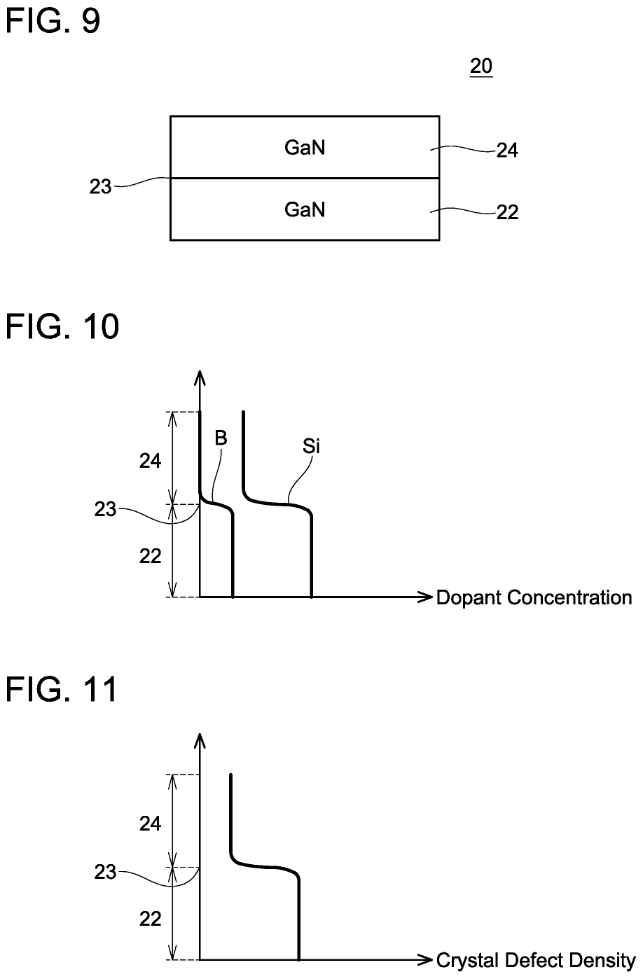

As shown in FIG. 9, for example, the film thickness of a semiconductor substrate 20 that is mainly constituted of gallium nitride may be measured. This semiconductor substrate 20 includes a first semiconductor layer 22 and a second semiconductor layer 24. As shown in FIG. 10, the first semiconductor layer 22 is doped with Si at a constant concentration in its depth direction and is additionally doped with boron (B) at a constant concentration in the depth direction. The concentration of B is lower than that of Si in the first semiconductor layer 22. The second semiconductor layer 24 is doped with Si at a constant concentration in its depth direction but is not doped with B. The concentration of Si in the second semiconductor layer 24 is lower than that in the first semiconductor layer 22. This semiconductor substrate 20 can be obtained, for example, by forming the first semiconductor layer 22 doped with Si and B at constant concentrations in the depth direction by Hydride-Vapor Phase Epitaxy (HVPE) using a boron nitride material, and then epitaxially growing the second semiconductor layer 24 on an upper surface of the first semiconductor layer 22 by the HVPE without using a boron nitride material.

The first semiconductor layer 22 of the above-described semiconductor substrate 20 contains B, and thus the first semiconductor layer 22 has a high crystal defect density as shown in FIG. 11. Therefore, in the distribution of the crystal defect density in the semiconductor substrate 20 measured along a thickness direction of the semiconductor substrate 20, a change amount of the crystal defect density is at its maximum at an interface 23 between the first semiconductor layer 22 and the second semiconductor layer 24. As such, the crystal defect density drastically changes at the interface 23 in the semiconductor substrate 20, and hence the measurement of the semiconductor substrate 20 by the film thickness measuring device 100 reveals that the interface 23 has optical properties different from those of the other portions of the semiconductor substrate 20. This enables accurate detection of the position of the interface 23.

Although a crystal defect density has its peak (local maximum value) or a local minimum value at the interface 13 between the first semiconductor layer 12 and the second semiconductor layer 14, the crystal defect density may have a local maximum value or local minimum value at a portion other than the interface 13.

Some of the features characteristic to the technology disclosed herein will be listed below. It should be noted that the respective technical elements are independent of one another, and are useful solely or in combinations.

In a configuration disclosed herein as an aspect, the same material may be a wide gap semiconductor, and the light source may emit visible light or ultraviolet light.

In such a configuration, the light emitted by the light source has a relatively short wavelength. This enables suitable measurement for the semiconductor layer having a film thickness on the order of micrometers.

In a configuration disclosed herein as an aspect, the film thickness measuring device may further comprise an objective lens disposed between the half mirror and the stage, and the method may further comprise adjusting a focus position of the light emitted onto the semiconductor substrate by moving the objective lens.

In such a configuration, the objective lens is disposed on the optical path where the light entering the semiconductor substrate overlaps the light reflected from the semiconductor substrate. Therefore, moving the objective lens facilitates adjustment of the focus position of the light emitted onto the semiconductor substrate.

In a configuration disclosed herein as an aspect, the first semiconductor layer and the second semiconductor layer may contain a dopant, and a concentration of the dopant may be at its peak at the interface between the first semiconductor layer and the second semiconductor layer.

In such a configuration, the interface between the first semiconductor layer and the second semiconductor layer has optical properties different from those of the other portions of the semiconductor substrate. This facilitates detection of the light reflected by the interface, and enables accurate detection of the position of the interface.

In a configuration disclosed herein as an aspect, the same material may be an oxide semiconductor.

In a configuration disclosed herein as an aspect, the first semiconductor layer and the second semiconductor layer may be of n-type, and the first semiconductor layer and the second semiconductor layer may contain a group IV element.

In a configuration disclosed herein as an aspect, the group IV element may be carbon or silicon.

In a configuration disclosed herein as an aspect, a concentration of oxygen atoms in the semiconductor substrate may be at its peak at the interface between the first semiconductor layer and the second semiconductor layer.

In such a configuration, the semiconductor substrate has a low crystal defect density at the interface between the first semiconductor layer and the second semiconductor layer. The interface therefore has optical properties different from those of the other portions of the semiconductor substrate. This facilitates detection of the light reflected by the interface, and enables accurate detection of the position of the interface.

In a configuration disclosed herein as an aspect, the oxide semiconductor may be gallium oxide.

In a configuration disclosed herein as an aspect, a crystal defect density in the semiconductor substrate may have a local maximum or local minimum value at the interface between the first semiconductor layer and the second semiconductor layer.

In a configuration disclosed herein as an aspect, in a distribution of a crystal defect density in the semiconductor substrate measured along a thickness direction of the first semiconductor layer and the second semiconductor layer, a change amount of the crystal defect density may be at its maximum at the interface between the first semiconductor layer and the second semiconductor layer.

When the crystal defect density is distributed as in each of the above-described configurations, the interface between the first semiconductor layer and the second semiconductor layer has optical properties different from those of the other portions of the semiconductor substrate. This facilitates detection of the light reflected by the interface, and enables accurate detection of the position of the interface.

In a configuration disclosed herein as an aspect, a switching element may be disposed in the semiconductor substrate, a resistance of the second semiconductor layer may be higher than a resistance of the first semiconductor layer, and the second semiconductor layer may be a drift layer of the switching element.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A method of measuring a film thickness of a second semiconductor layer covering a surface of a first semiconductor layer by using a film thickness measuring device, wherein
the first semiconductor layer and the second semiconductor layer are mainly constituted of a same material and are of a same conductivity type,
the film thickness measuring device comprises a light source, a stage, a half mirror, a photodetector, and a film thickness calculator,
the method comprises:
fixing a semiconductor substrate including the first semiconductor layer and the second semiconductor layer to the stage; and
measuring the film thickness of the second semiconductor layer with the film thickness measuring device,
wherein
the film thickness measuring device is configured such that light emitted from the light source is reflected by the semiconductor substrate fixed to the stage after having been reflected by the half mirror, and the light reflected by the semiconductor substrate passes through the half mirror and enters the photodetector,
the light reflected by the semiconductor substrate includes first reflected light reflected by a surface of the second semiconductor layer and second reflected light reflected by an interface between the second semiconductor layer and the first semiconductor layer, and
the film thickness calculator calculates the film thickness of the second semiconductor layer based on the light detected by the photodetector.

2. The method of claim 1, wherein
the same material is a wide gap semiconductor, and
the light source emits visible light or ultraviolet light.

3. The method of claim 1, wherein
the film thickness measuring device further comprises an objective lens disposed between the half mirror and the stage, and
the method further comprises adjusting a focus position of the light emitted onto the semiconductor substrate by moving the objective lens.

4. The method of claim 1, wherein
the first semiconductor layer and the second semiconductor layer contain a dopant, and
a concentration of the dopant is at its peak at the interface between the first semiconductor layer and the second semiconductor layer.

5. The method of claim 1, wherein
the same material is an oxide semiconductor.

6. The method of claim 5, wherein
the first semiconductor layer and the second semiconductor layer are of n-type, and
the first semiconductor layer and the second semiconductor layer contain a group IV element.

7. The method of claim 6, wherein
the group IV element is carbon or silicon.

8. The method of claim 5, wherein
a concentration of oxygen atoms in the semiconductor substrate is at its peak at the interface between the first semiconductor layer and the second semiconductor layer.

9. The method of claim 5, wherein
the oxide semiconductor is gallium oxide.

10. The method of claim 1, wherein
a crystal defect density in the semiconductor substrate has a local maximum or local minimum value at the interface between the first semiconductor layer and the second semiconductor layer.

11. The method of claim 1, wherein
in a distribution of a crystal defect density in the semiconductor substrate measured along a thickness direction of the first semiconductor layer and the second semiconductor layer, a change amount of the crystal defect density is at its maximum at the interface between the first semiconductor layer and the second semiconductor layer.

12. The method of claim 1, wherein
a switching element is disposed in the semiconductor substrate,
a resistance of the second semiconductor layer is higher than a resistance of the first semiconductor layer, and
the second semiconductor layer is a drift layer of the switching element.
